(19) United States
(12) Patent Application Publication
(10) Pub. No.: US 2006/0004598 A1
(43) Pub. Date: Jan. 5, 2006

(54) System for effecting customized pricing for goods or services

(76) Inventors: Dean W. Boyd, Cottage Grove, OR (US); Thomas E. Guardino, Eugene, OR (US); Henry F. Schwarz, Foster City, CA (US); Robert A. Flint, Redwood City, CA (US)

Correspondence Address: MARGER JOHNSON & MCCOLLOM, P.C., 210 SW MORRISON STREET, SUITE 400, PORTLAND, OR, 97204, US

(21) Appl. No.: 11/169,201

(22) Filed: Jun. 27, 2005

Related U.S. Application Data
(60) Provisional application No. 60/583,246, filed on Jun. 25, 2004.

(51) Int. Cl. G06F 17/60

(52) U.S. Cl. 705/1

(57) ABSTRACT

The system for implementing Customized Pricing includes, in a preferred embodiment, four modules operable within a server or workstation environment, including a CP Statistics Calibration module, a CP Pricer, a CP Strategy Tool, and a CP Performance Monitor. The CP Statistics Calibration module examines the historical pricing proposals and their corresponding subsequent fulfillment data (e.g., what products were delivered at the offered prices). The historical pricing proposals are generated from or stored within databases coupled to the system. The CP Statistics Calibration module generates the market response parameters that are key to quantifying predicted future buyer behavior. Customer response behavior to various offers for products is preferably modeled using a Zero Inflated Regression Model approach. The CP Pricer software module is operative to construct a pricing proposal using the market response parameters generated by the CP Statistics Calibration module. The CP Strategy Tool coupled to retrieve market response parameters from said CP Statistics Calibration module and strategic goal information from said computer database and generating impacts on said strategic goals cooperative with pricing proposals received from said CP Pricer software module. The CP Performance Monitor operative within the system to receive fulfillment history from records of buyer responses to prior pricing proposals, and periodically monitor a variance from a model established from the market response parameters.

### CROSS-REFERENCES TO RELATED APPLICATIONS

This application claims the benefit from U.S. Provisional Patent Application No. 60/583,246 filed Jun. 25, 2004 whose contents are incorporated herein for all purposes.

### BACKGROUND OF THE INVENTION

1. Field of the Invention

This invention relates generally to methods and systems for pricing products such as goods and services, and more particularly to systems capable for effecting pricing customized for various potential purchasers of the products.

2. Description of the Prior Art

Buyers and sellers traditionally exchange information, goods, and services for money through one of several methods. In the most common of these, the seller sets the price, and the buyer either accepts that price or does not accept (for example, retail, or most classified ads). In another common method, the buyer and seller agree to a price (for example, a flea market, or a classified ad which includes ‘or best offer’). Sometimes buyers compete and the highest price offered wins (for example, a standard auction, a reverse auction, or a Dutch auction). In the alternative, sometimes sellers compete and the lower price offered wins as in reverse auctions and compete for a given buyer (for example, a ‘wanted to buy’ classified ad). Other commerce systems are exchange-driven, and buyers and sellers are matched in an orderly marketplace (such as the NASDAQ or the New York Stock Exchange).

In all of these buyer-seller protocols, the buyer and seller agree to the price and other payment terms before the information, goods, and services are provided. Several U.S. patents relate to on-line electronic communications and processing of transactions between multiple buyers and sellers with these various buyer-seller protocols. But for every single one of these, the buyer and seller agree to a price before the transaction is completed; indeed, if an agreement on price and other terms cannot be reached, the transaction does not occur.

It is common practice for providers of goods and/or services, herein called the seller of products, to offer different prices to different customers. A large purchasing power by the buyer, for instance from large retailers such as Wal-Mart, may force a seller to set a lower price for the products to reflect corporate savings in negotiating with a single buyer, savings on shipping and other factors. Methods for setting different prices, however, have often not been performed in systematic ways to achieve corporate goals set by the seller.

Accordingly, the need remains for improved systems and methods for pricing products to various customers which better achieve these economic goals set by the seller.

### SUMMARY OF THE INVENTION

A Customized Pricing System constructed according to teachings of the invention is operable within a corporate computer environment including, in a basic form, a pricing workstation, a pricing proposal document production system for generating and recording within a database pricing proposals, and a database including competitor information. Other database systems can be integrating including an order acquisition and fulfillment workstation, and databases storing invoicing and receivables data, fulfillment data, and pricing data.

The Customized Pricing System is typically integrated with systems and databases supporting four sets of processes. Process 1 includes the creation and management of account information; the creation, publication, and archiving of price proposals; and the capture and maintenance of competitive information. Process 2 includes the determination of prices to be offered and their loading into appropriate databases. Process 3 addresses the taking of orders under existing pricing terms. And Process 4 includes the fulfillment of these orders and the appropriate invoicing to the buyer as well as the capture of the fulfillment information.

The system for implementing Customized Pricing includes, in a preferred embodiment, four modules operable within a server or workstation environment. A CP Statistical Calibration module examines the historical pricing proposals and their corresponding subsequent fulfillment data (e.g., what products were delivered at the offered prices). The historical pricing proposals are generated from or stored within databases coupled to the system. The CP Statistical Calibration module generates the market response parameters that are key to quantifying predicted future buyer behavior. Customer behavior to various offers for products is preferably modeled using a Zero Inflated Regression Model approach.

The Zero Inflated Regression Model includes both a Zero Inflated Component and a Non-negative Regression Model Component. The Zero Inflated Component is used to calculate the likelihood that the customer will have a non-zero demand for the product as a function of price. The Non-negative Regression Model assumes that demand is zero with some probability q (the Zero Inflation Model) and a draw from some non-negative distribution f( ) (the Non-negative Regression Model) with probability 1−q. The total probability of seeing zero demand is q+(1−q)f(0). Both q and f( ) are expressed as functions of customer, product, and other attributes as described below. The Non-negative Regression Model can be used in place of a Count Model (which is just a class of the Non-negative Regression Model) to extend the ability of the invention to yield continuous or fractional results.

Once the customer model for the particular products is generated by the CP Statistical Calibration module, the model metrics are communicated to a CP Pricer module, operable on the same or different workstation/server. The Pricer module determines the Customized price for each product in a given price proposal that is under consideration.

A third module, the CP Strategy tool, uses the CP Pricer in a “what if” mode, allowing a user to see the effects on price and on the customer performance metrics of changes in market parameters such as customer buying behavior or competition or of changes in costs or of changes in business rules such as required return on capital. Reports comparing predicted buyer behavior with buyer actual behavior are performed within a CP Performance Monitor module. The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram illustrating a customer pricing system configured according to a preferred embodiment of the invention to implement customized pricing methods.

FIG. 2 is a block diagram of customized pricing system modules which implement methods according to a preferred embodiment of the invention.

FIG. 3 is a block diagram of a CP Statistical Calibration Module portion of the customized pricing system of FIG. 2.

FIG. 4 is a block and flow diagram illustrating the operation of the CP Statistical Calibration Module from FIG. 3.

FIG. 5 is a block diagram of a Pricer Module portion of the customized pricing system of FIG. 2.

FIG. 6 is a block and flow diagram illustrating the operation of the Pricer Module of FIG. 5.

FIG. 7 is a block diagram of a Strategy Tool Module operable within the customized pricing system of FIG. 2.

FIG. 8 is a block diagram of a Performance Monitor module operable within the customized pricing system of FIG. 2.

FIG. 9 is a flow diagram illustrating an implementation of the method for customized pricing practiced according to a preferred embodiment of the invention.

### DETAILED DESCRIPTION

This document describes the preferred implementation of a Customized Pricing System implemented according to teachings of the invention. A Customized Pricing System implements methods for Customized Pricing which will be discussed further below.

Use of the Customized Pricing System to implement customized pricing methods is most applicable under the following conditions. The first condition is where the nature of the industry is such that prices are at least to some extent negotiated between seller and buyer. The second condition is where sellers have freedom in setting their prices, and, in particular to offer different prices to different buyers. The third condition is where buyers decide which seller or sellers to buy from, and in what volume, based on prices offered, quality, competition, and all characteristics of the offering

Among the particulars that tend to vary from situation to situation are: (1) the accuracy with which the seller can cost the products offered; (2) the data that is (or can be) captured and stored in the seller's information systems; (3) for each data field, the accuracy and reliability of the captured data; (4) for a particular seller, which data fields can be shown to be statistically significant and useful as a predictor of the purchasing behavior of particular buyers; (5) the information technologies that are used for the seller's existing data capture systems and the seller's preferred information technologies for implementing a Customized Pricing System and integrating it with existing systems; and (6) whether the seller's organization and business process for setting prices is centrally managed and controlled, or is distributed and, in either case, the specific types of “management controls” the customer desires to build into the Customized Pricing System?

The generic Customized Pricing System described here is designed to accommodate such variations. The remainder of this document describes how this Customized Pricing System integrates into a seller's computational environment, facilitates construction of a specific Customized Pricing System for a particular customer in a particular industry, is decomposed into a set of computer software modules that implement the Customized Pricing Methods, and is designed to be deployed on a preferred configuration of computer hardware, but which can also be deployed to alternate configurations that may better suit a particular situation. We begin with an explanation of how the Customized Pricing System integrates into a seller's computational environment. This explanation will also serve to define several terms and concepts, and to define the context in which Customized Pricing takes place.

The Customized Pricing System requires a large and diverse set of data as input. The required data is normally captured by and preserved within the seller's existing information systems. The Customized Pricing System includes a layer of software and hardware that serves to make this set of external data available to the Customized Pricing System.

The data is organized around several concepts that correspond to business entities in the real world. Definitions used herein are as follows:

“Seller”—the business entity that uses Customized Pricing to set prices to its buyers.

“Products”—the Goods or Services that are offered by the seller.

“Account”—the buyer (or prospective buyer) of product(s) from seller.

“Pricing Proposal”—an offer by a seller to a buyer specifying the buyer's prices on a set of goods or services. The proposal or offer may be made in response to a request for proposal by the buyer or may be initiated by the seller.

“Line Item”—An element of Pricing Proposal that involves a single product, to be transacted at a single price.

“Order”—a request for Seller to provide specified products covered under a Pricing Proposal.

“Transaction”—an Order that has been fulfilled.

“Fulfillment Data”—an electronic collection of Transaction data that includes, for each Transaction, an identification of the governing Line Item of the pertinent Pricing Proposal and the calculation of amount due (i.e., the invoice amount).

“Competitor”—another seller that offers similar or competing products.

In general there are four factors that drive the need for specific data elements to be available in order for Customized Pricing to be applied. First, there is a need for consistent (or, at least, unambiguously resolvable) use of unique identifiers to represent the entities mentioned above. Second, there is a need for the data to include elements that can be reasonably expected to be useful in predicting future behavior by Accounts in responding to Seller's Pricing Proposals. We will elaborate on this below. Third, there is a need for data pertaining to “Products” to include sufficient details so as to permit reasonably accurate estimation of the cost of providing the Product, as well as to enable formation of broad “categories” of Products that have similar fundamental characteristics. This will be further explained below. And fourth, there is a critical need for the on-going capture, organization, and retention (e.g., in a database or databases) of all Pricing Proposals that the Seller has issued; and there is a need for Fulfillment Data to include a unique identifier that explicitly “links” each Transaction to the Line Item that specifies the terms of pricing that were used to invoice the Transaction. We will briefly discuss each of these items in the following paragraphs.

There is a critical need for unique identifiers on the entities discussed above such as “Buyer” or “Account” and “Pricing Proposal”. For example, the Seller may assign a unique Account Number such as “123-45-6789” to represent the Account named “ABC Incorporated”, so as to avoid (or resolve) inconsistencies or variations such as “ABC”, “ABC Corp”, and “ABC Inc.”

With respect to the second factor, the types of data that have been shown to have value in predicting an Account's response to future Pricing Proposals include:
Various measures of the “size” of the Account, such as:
   Account's annual gross revenues
   If a subsidiary or part of a conglomerate, the “parent” organization's annual gross revenues
   Account's past annual expenditures on Products offered by Seller. Where possible, this should be further broken down as follows:
      Past annual expenditure on Products purchased from the Seller (as opposed to purchased from Competitors)
      Past annual expenditures on each type of Product purchased (including Products purchased from Competitors)
   If available, expected future annual growth rates for all of the above items
Some classification of the Account organization's line of business, such as the industry (or industries) that Account organization is in.
If geography is a pertinent characteristic in the definition of “Products,” then the data should include some classification or enumeration of the geography in which the Account organization operates.
The level of Account's current utilization of Competitors, such as:
   The number (and unique identifiers) of Competitors that are currently providing a significant volume of Products to the Account
   If known/available, information about the Competitors Pricing Proposal. This can be broad (e.g., did Competitor make any offer at all?), or quite detailed (what prices did Competitor offer, for which Products?)
Some classification of the nature of the Pricing Proposal, e.g.,:
   Is it in response to a request for proposal? Is it a “sole source” request? Or is it a “competitive” bid?
   Is it offered at the Seller's initiative?
   Will Account award the entire scope of the business to single “winner”? Or is the Account free to “pick and choose”, awarding portions of the business to multiple suppliers?
   If a competitive Pricing Proposal, which Competitors are included?
If applicable, data on “prevailing prices” for Products.
If applicable, Seller's current List Prices. And if known, Competitor's List Prices.
Where applicable, the most recent previous price proposed by Seller to the Account for the same Product(s).

With respect to factor (3), there is high variability in how “Products” are defined in different industries, and it is therefore difficult to define in a generic manner. In general, Customized Pricing requires a definition of Products such as would typically be used to structure prices for the Product. For example, in transportation industries, the following dimensions and/or attributes are often used in setting prices:
“Season.” Airlines, for example, publish different prices for different times of the year.
“Service Commitment”. An airline, for example, may offer 2 or 3 distinct classes of service (first class, business class, coach).
“Mode” of service. For example, freight transportation services may be offered via air, truck, or rail.
“Geography”. In transportation industries, pricing usually depends on both “origin” and “destination.”
“Size”. In airlines, this is simply the number of seats being requested. In a shipping industry, it involves the physical size and weight of the object being shipped.
“Options” or “Features.” A specific order for a Product may include a request for certain options or features. For example, in the truckload shipping industry a shipping order may include a request for the driver to assist in loading the freight to be shipped.

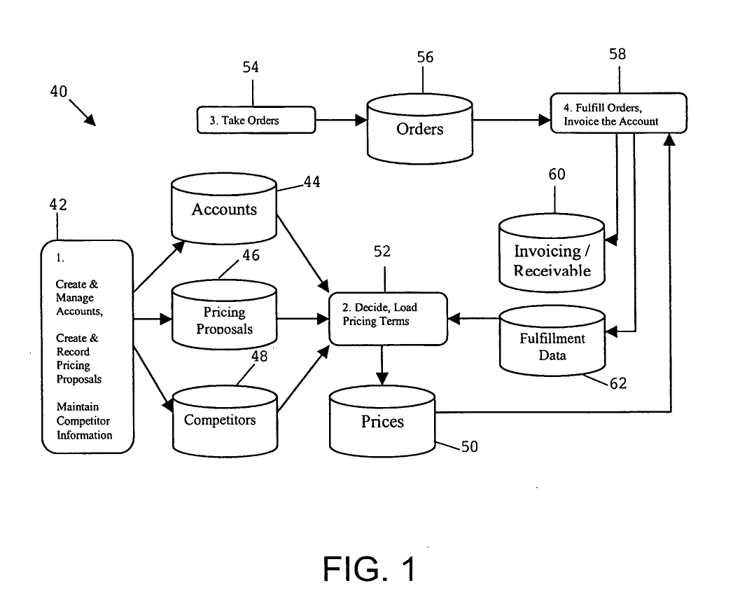

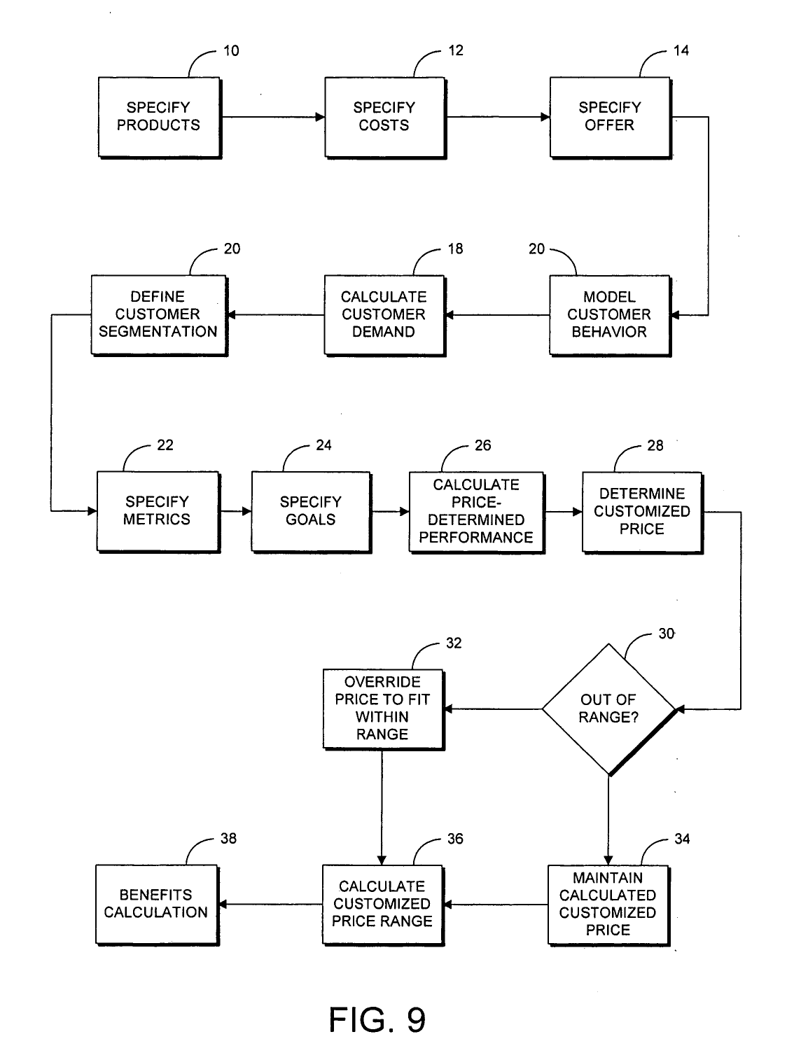

With respect to how the above data is organized, a typical Seller configuration is shown at 40 in FIG. 1. System 40 incorporates one or more computers one which operate applications that interact with informational databases to operate the seller's business. For instance, a workstation 42 can be used operate programs thereon which create and manage customer accounts, create and record pricing proposals to those customers, and maintain competitor information in databases 44, 46, and 48. Pricing terms, typically determined in conjunction with information noted in a pricing database 50, are determined using application 52. It should be noted that the decide/load pricing terms application can also operate on the same computer as workstation 42 or a different workstation on the same network within system 40. As orders are taken at order input 54, orders are stored within order database 56 and processed by fulfillment station 58. Invoices are issued to the account and instructions are sent to the appropriate locations so that orders are supplied as appropriate. Data from this process is stored in invoicing/receivable database 60 and in fulfillment database 62. Again, all operations could potentially be operated on a single computer and that the block diagram in FIG. 1 is intended only to represent an IT environment to implement the present invention. Fulfillment data is communicated back to the pricing block 52 according to methods described above to track ongoing pricing as a check against the purchase model constructed in block 20 (FIG. 9).

The Customized Pricing System and Method operates within the pricing block 52 and represents a particular seller's IT environment supporting the establishment of prices and will usually include pre-existing seller-specific computer applications, to which the Customized Pricing System can be added in order to augment seller's IT support for making pricing decisions. Thus, block 52 does not equate to the Customized Pricing System, but shows its overall context within the seller's IT environment.

The generalized Customized Pricing System facilitates the design and construction of a specific Customized Pricing System (for a particular Seller within a particular industry) in several ways. First, with respect to data entities and data fields, it serves as a “check list” for reviewing the Seller's existing information systems and data, help to identify key data that Seller does not currently capture or retain, and also helping to identify the particular form that relevant data takes in Seller's environment. Second, to the extent that the review uncovers key relevant data that is not currently captured or retained, it provides a model for how Seller's existing information systems might be enhanced so as to include the capture and retention of the data. Third, it provides a general design for the data interfaces between the Seller's existing information systems and the (new) specific Customized Pricing System. Fourth, it provides a general design for the implementation of Customized Pricing Methods within the (new) specific Customized Pricing System. And fifth, it provides a flexible, robust framework that increases the potential for re-using software components of previously-constructed specific Customized Pricing Systems (i.e., ones developed for other Companies in the same or different industries) with minimal changes to software.

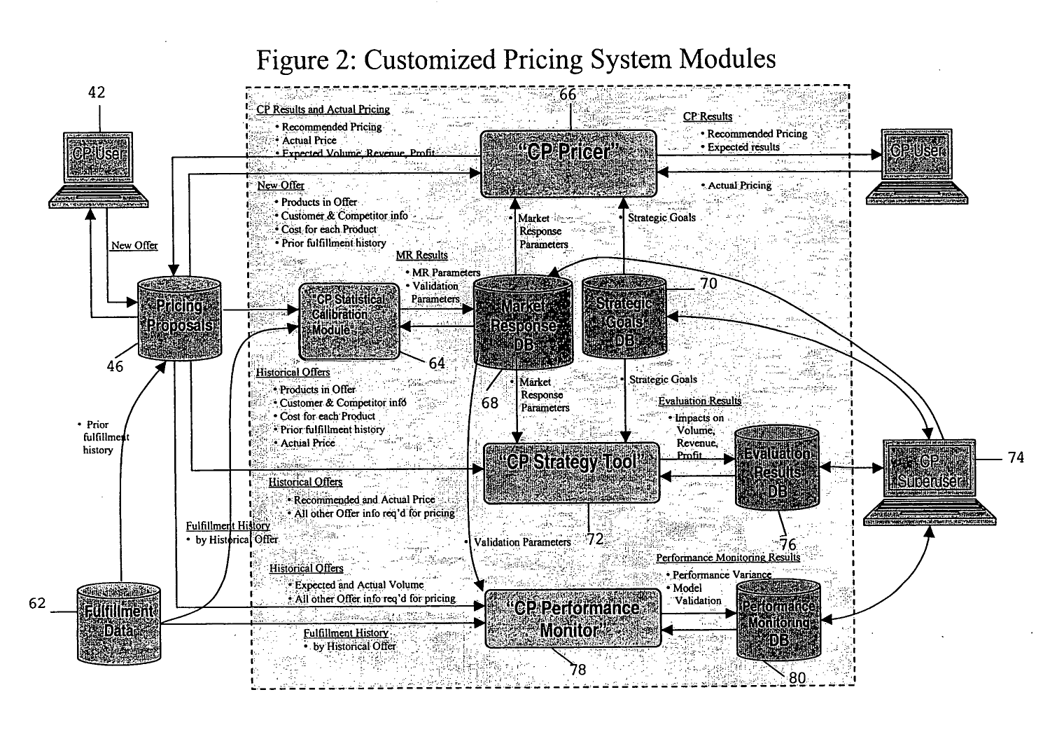

FIG. 2 shows the decomposition of the Customized Pricing System into its four primary software modules.

The CP Statistical Calibration Module 64, examines historical Pricing Proposals and their corresponding subsequent fulfillment data in generating the market response parameters that are key to quantifying predicted future Buyer behavior. Following the flow of information shown in FIG. 2, fulfillment database 62 supplies the Statistical Calibration Module 64 with data on past offers and fulfillment, including for each offer made the products in the offer, the customer and competitor information, the cost for each product, and the actual price under contract with the customer.

The CP Pricer Module 66, determines the Customized Price for each Product in a given Pricing Proposal that is under construction. Operation of this module is described above in connection with the modeling method described in connection with FIG. 9. Market response parameters are supplied to module 66 from market response database 68 as well as strategic goals used in the calculation, stored in strategic goals database 70. New offers (including products in the offer, customer and competitor information, cost for each product, and prior fulfillment history) are communicated to Price Module 66 and calculations performed using, in a preferred embodiment, the Zero Inflated Regression Model for the customer and industry are performed to arrive at a recommended price that meets the seller's strategic goals.

The CP Strategy Tool Module 72, which uses the CP Pricer Module 66 in a “what if” mode, allows a user to see the effects on price of changes to market and performance measurement assumptions, performance objectives and/or pricing constraints. Strategy module 72 uses historical offer information from pricing proposal database 46, market response parameters from database 68, and strategic goals from database 70 to predict the effect from contracted price changes with the customer. The customized price superuser, operating on workstation 74, inputs and receives varied data through the strategy tool module 72 via evaluation results database 76.

Finally, the CP Performance Monitor Module 78 generates reports that compare predicted Buyer behavior with Buyer's actual behavior. In operation, module 78 uses validation parameters that are communicated to module 78 from market response database 68, historical offer data including expected and actual volume and other information from pricing proposal database 46, and fulfillment historical data from database 62. Performance variance and model validations are communicated through performance monitoring database 80 to the superuser working at workstation 74.

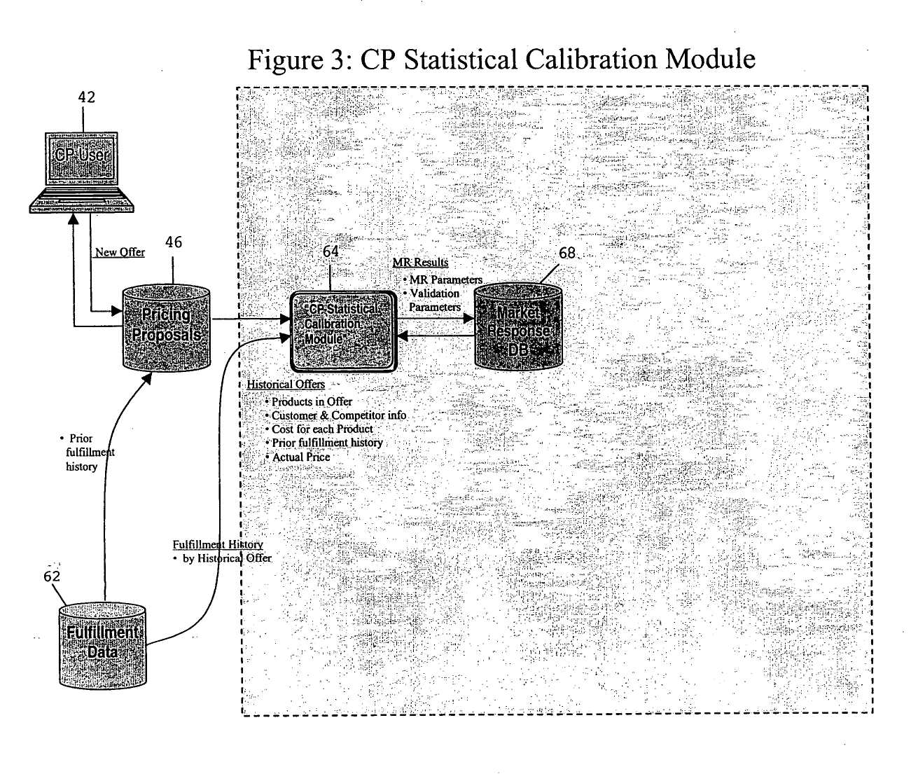

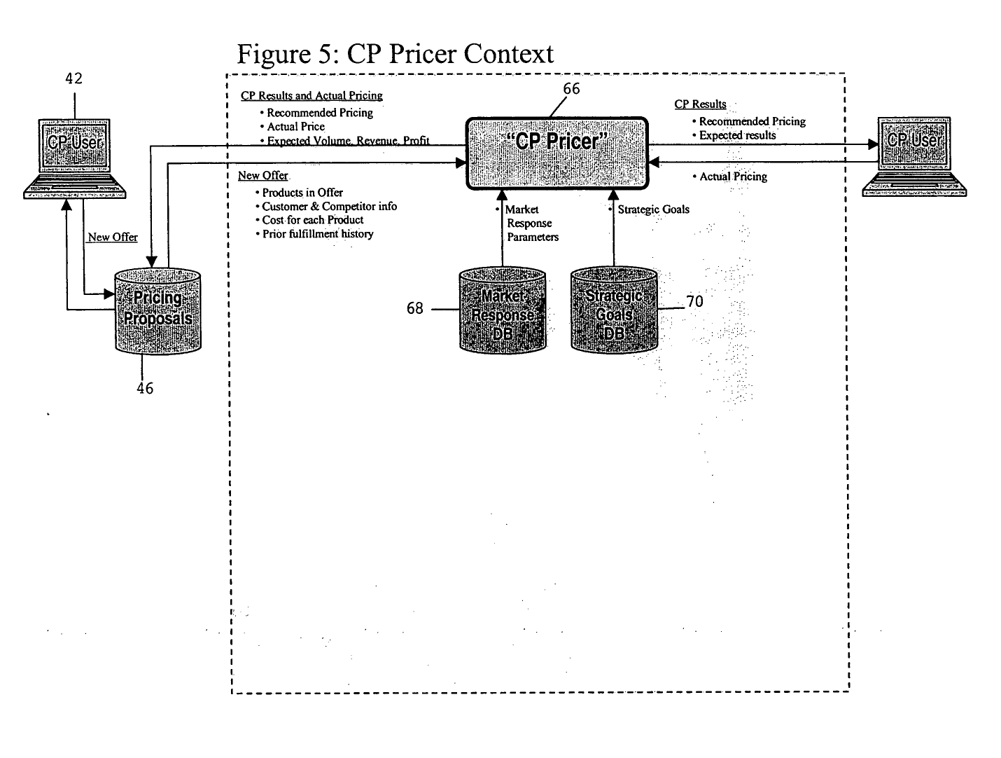

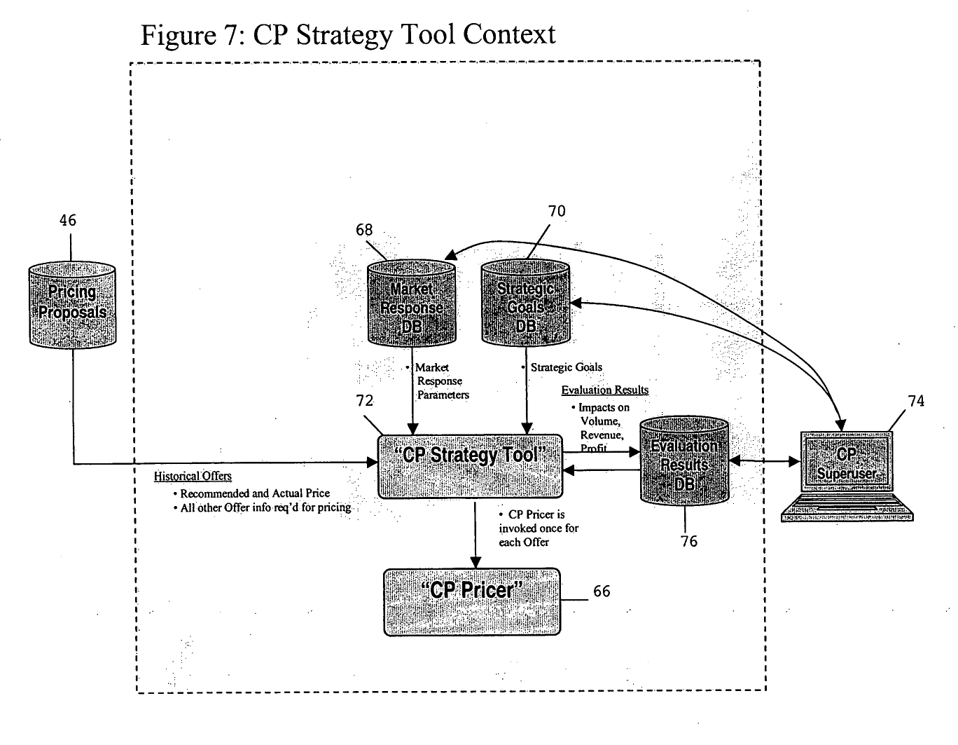

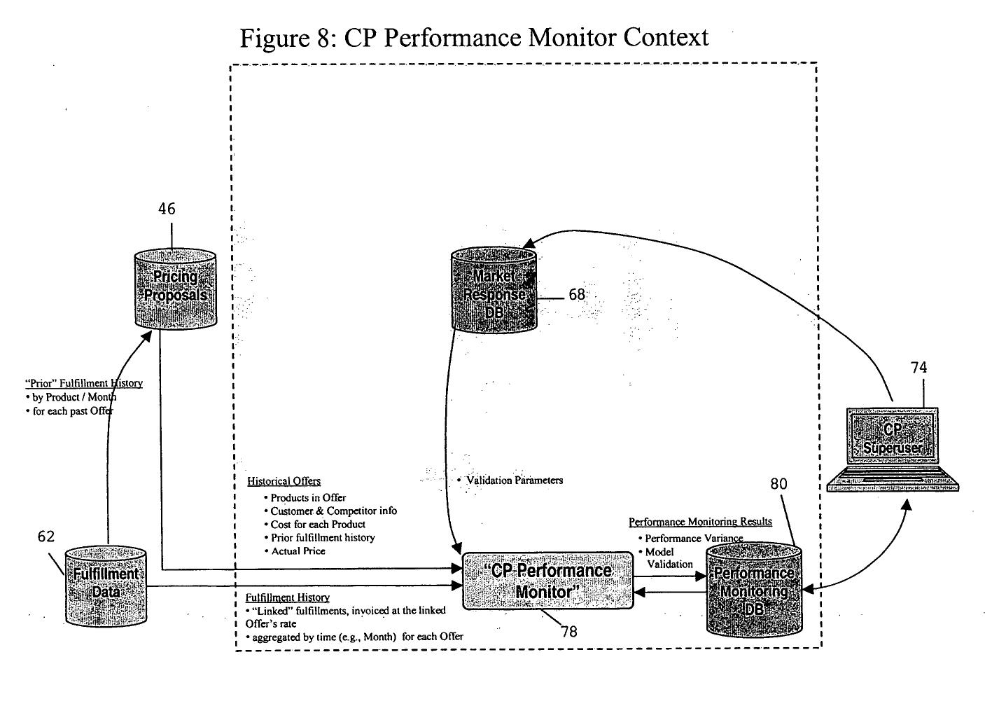

FIGS. 3-8 provide additional detail on the four modules, including the context for each module (i.e., limited to data flow in and out), the internal design for some modules, the common elements among CP Statistical Calibration module and CP Pricer, and the relationship between CP Strategy Tool and CP Pricer.

Note that FIGS. 2 through 8 all assume that CP-required Customer and Competitor data exists in the Pricing Proposal database 46, rather than in separate databases. This is per the preferred configuration, as explained below. The flow of information is shown in the figures.

The preferred hardware and software configuration for Customized Pricing includes systems where all server hardware platforms are symmetric multi-processing (SMP) computers running under a POSIX-compliant UNIX operating system. All databases are preferably implemented under Oracle or DB2. One server hosts the Customized Pricing database. This server also hosts the commercial statistical/numerical package that is used by the calibration process of the CP Statistical Calibration module 64 and the CP Performance Monitor module 78. The preferred commercial statistical/numerical package is SAS. One server hosts the Pricing Proposal database 46 where the Pricing Proposal database includes snapshot copies, made at the time of Pricing Proposal preparation, of all data contained in the “Accounts” and “Competitors” databases that are input to the Customized Pricing System. One server hosts a J2EE 1.4-compliant Application Server, which is the point of contact for Customized Pricing services and related web-based user interface functions. All servers are configured to support TCP/IP and FTP communication protocols.

Data interfaces between the Customized Pricing System and Seller's external systems are implemented in two ways. First, data interfaces that provide input data to the CP Statistical Calibration module 64 and CP Performance Monitor 78 are implemented as batch processes that extract the needed data from external sources, format that data as a set of pipe-delimited text files, and use FTP to copy the files to the CP database/statistical process server. Second, data interfaces that support the CP Pricer module 66 are implemented as J2EE 1.4 services (i.e., calls to J2EE 1.4 stateless session EJBs).

The method for delivering Customized Pricing using the system described above involves several steps. In a first step, goods or services (“products”) are specified using data stored within the price proposal database 46. The costs for providing these products is specified from data also within the price proposal database 46. The characteristics of the offer made to the particular customer is retrieved from data stored within the pricing proposal database and forwarded for calculations by the CP Pricer Module 66.

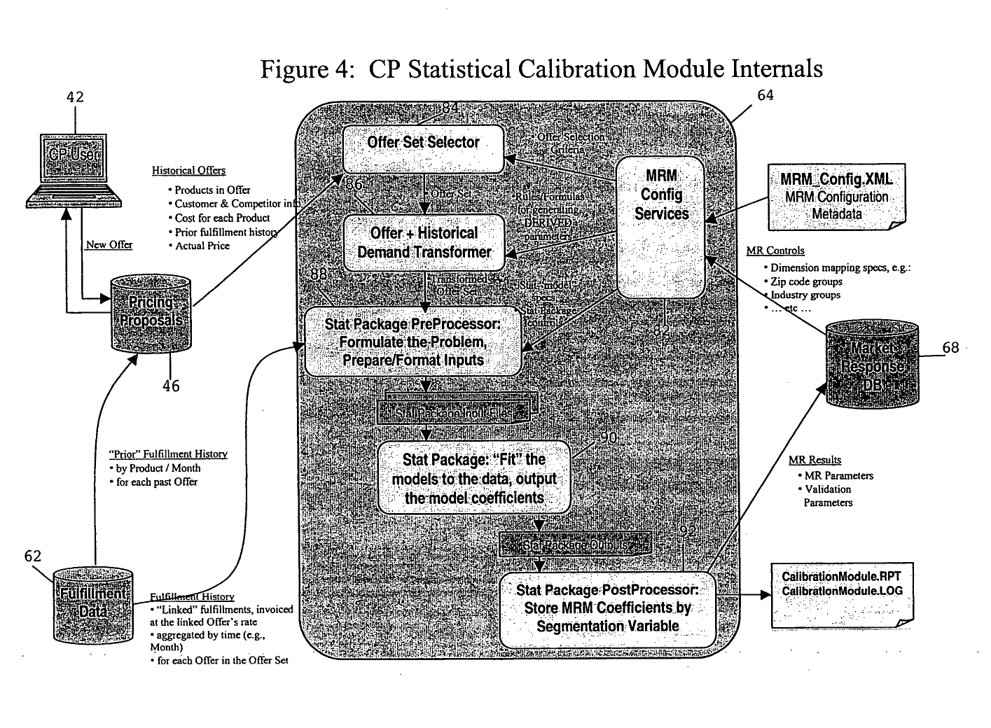

Customer buying behavior is captured by making statistical inferences based on past customer behavior responsive to offers and the characteristics of those offers. The common element “MRM Config Services” 82 (FIG. 4) specifies the functional form of the demand model and its parameters. The CP Statistical Calibration module 64 implements the method for making the actual inferences and the CP Performance Monitor 78 implements methods for monitoring the accuracy of the inferences over time. Inferences are preferably made by using a Zero Inflated Regression Model approach.

Based on the customer behavior model presented, expected customer demand is calculated. Again, the common element “MRM Config Services” specifies the functional form of the demand model and its parameters as shown in the flow diagram of FIG. 4.

Turning to FIG. 4, then, MRM Config Services 82 draws data from market response database 68 and implements the model calculation by feeding offer selection criteria to the offer set selector 84, supplies the rules and formulas to the offer+historical demand transformer 86 for generating derived statistical parameters, and supplies stat “model” specifications and package controls to the Stat Package Preprocessor 88 to formulate the problem and prepare/format inputs.

For each offer in the historical offer set, fulfillment database 62 supplies to preprocessor 88 fulfillments invoiced at the offer's rate and such data is figured in the formulations performed by preprocessor 88 from the information provided to the various submodules. Stat Package 90 fits the models to the supplied data and outputs the model coefficients to the Stat Package Postprocessor 92.

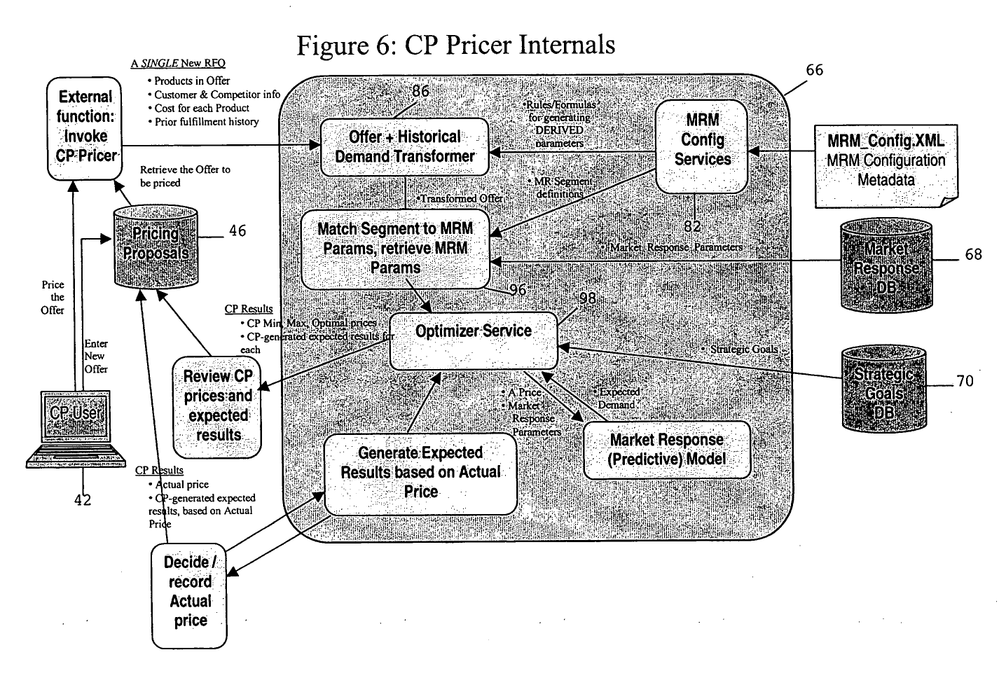

The CP Pricer model element “Market Response (Predictive) Model” 94 in FIG. 6 applies the method for the purpose of calculating expected demand at various possible prices. Customer segmentation is then defined using the common element “MRM Config Services” 82 which implements knowledge of the observable data (and/or transforms thereof) that define customer segmentation. A CP Pricer module element (“Match Segment to MRM Params, retrieve MJM Params” 96) implements the method of identifying an offer's customer segment based on the offer characteristics. Seller performance metrics are then specified within the CP Pricer module element “Optimizer Service” 98.

Goal attainment is then calculated. The seller's performance goals (e.g., maximize profits) are specified using the CP Pricer module element “Optimizer Service” 98. The seller's performance metrics are then calculated by that module as a function of price. From this, a Customized price is determined that optimizes the achievement of the seller's performance goals. If this Customized price falls outside of some statistically valid range, then the calculated price should be overridden and replaced by the appropriate minimum and maximum of the statistically valid price range. Finally, using the values of the seller's performance metrics as a function of price, choose a Customized Price Lower Limit and Customized Price Upper Limit that yield values of the seller's performance goal within a specified tolerance. The price range is then determined and stored. Benefits of the offer made and the Customized price specified is calculated for a single offer. The CP Strategy Tool module provides the capability of calculating the benefits of Customized Pricing based on a set of offers and under various assumptions.

The preferred method for using the system described above to implement Customized Pricing is as follows. As Customized Pricing is a unique method for a seller to price products, the prices are customized to the specific characteristics of the products offered by the seller to a specific customer, the cost to the seller of providing the products to the specific customer, the seller's performance goals in selling the products to the specific customer or to a set of customers, and the specific customer's buying behavior in making decisions to purchase the offered products.

A more specific implementation of price customization is achieved in the following steps: (1) specifying the products, (2) specifying the costs for providing the products, (3) specifying the offer, (4) modeling customer behavior from past encounters, (5) calculating expected customer demand, (6) defining customer segmentation, (7/8) specifying sellers performance metrics and goals, and (9-13) customizing the prices according to sellers stated goals. These steps are described in the following paragraphs:

1.0 Specify the Goods or Services

The first step in Customized Pricing is to specify the goods or services (hereinafter “products”) that will be offered to the customer, as in block 10 of FIG. 9. This specification should be at the level at which the seller anticipates potentially differentiating prices to the customer. In general, the number of products differentiated in this way will be very large. Furthermore, customers will often demand only a small fraction of the possible products. This leads to the so-called sparse data problem when analyzing historical customer demand.

For example, consider services offered in a geographically distributed transportation network. A seller might offer truckload transportation services from an origin in this network to a destination. The set of services to be Customized Priced would then include truckload transportation on all combinations of origins and destinations that the seller serves in this network. Thus the dimensionality of the service offering is the set of all possible origin-destination combinations. However, a particular customer will actually have demand for only a small subset of these combinations leading to the sparse data problem in this particular example.

The specification of the products requires a clear definition of the product that the seller provides at the level of detail at which the seller desires to price the products. This specification does not require that the seller assign list prices to the products and thus is different from other methods, such as Target Pricing, currently practiced by those knowledgeable in the art.

2.0 Specify the Costs of Providing the Products

In block 12, the seller must define the cost of providing each of the products defined in block 10 to the set of customers to whom the seller anticipates potentially offering some or all of the products. These costs should include the opportunity costs (or indirect costs) of any assets used to produce the products as well as all direct costs. Note that in general the cost of providing products may vary with the customer to whom the products are provided.

For example, consider the cost of providing truckload transportation services from an Origin A to a Destination B for two different Customers X and Y. The cost per mile of moving the truck will likely be the same for both customers. However, the handling costs for Customer X might be significantly greater than the handling costs for Customer Y. Thus, the cost of providing the service to the two different customers will be different.

3.0 Specify the Offer

Generally customers will desire to purchase products in bundles or groups rather than individually. In block 14, the seller will establish the prices for of the bundled products in an offer or pricing proposal. An offer or pricing proposal could consist of a price for a single product offered by the seller, a set of prices for a set of such products or a single price for a set of products.

For example, a customer might desire to purchase truckload transportation services from a distribution center located at Point A to a set of three retail outlets located at Point X1, Point X2, and Point X3.

The products in an offer may be considered independently or the customer may put constraints on how the seller prices the products in the offer.

In the example above, the seller might normally provide a set of three prices for the truckload transportation services:
1. From Origin A to Destination X1.
2. From Origin A to Destination X2.
3. From Origin A to Destination X3.

Alternatively, the customer might require a single price for truckload transportation services from Origin A to any of the Destinations.

4.0 Capture Customer Buying Behavior by Making Statistical Inferences Based on Past Customer Behavior

The customer's buying behavior is modeled in block 16 by making statistical inferences based on the following data:
The characteristics of all offers or pricing proposals—What specific products were offered at what prices to what customer.
Pre-offer fulfillment—What products were purchased at what prices prior to each of the offers.
Post-offer fulfillment—What products were purchased at what prices subsequent to each of the offers.
Customers—Who were the customers to whom the offers were made.
Customer characteristics—What are the characteristics of the customers to whom each of the offers is made.
Competitors—Who were the competitors on each of the offers.
Competitor characteristics—The characteristics of each competitor.

This list is meant to summarize the core data. In particular applications, additional data such as information about the market or macroeconomic indicators may also be useful. In addition, there is no assumption that the data will be perfect and all encompassing. In fact, in most cases, the data in many categories will be limited. The statistical modeling will determine whether the data available is sufficient. All of the available data becomes input to the statistical analysis process that is used to define customer buying behavior.

This inference is made in two steps. First, calculating the likelihood that the customer will have a non-zero demand for an offered product as a function of price. Second, given that there is a demand, calculating the expected level of demand as a function of price.

The two-step statistical inference defining the customer buying behavior is accomplished using a Zero Inflated Regression Model where a Zero Inflated model is used to calculate the probability that the customer may have a non-zero demand for the product as a function of price, and a Non-negative Regression Model is used to calculate the expected demand for the product given that the customer may have a non-zero demand. A Count Model is a special circumstance of the Non-negative Regression Model and be used in place of the Non-negative Regression component to address only integer amounts of products.

The Zero Inflated Regression Model approach has the ability to handle in a statistically meaningful manner the sparse data matrices that are often generated with products of high dimensionality in block 10. Many traditional approaches such as logistic regression do not have this ability to effectively make inferences from sparse data matrices. This is as opposed to other pricing schemes, such as Target Pricing, which are based on logistic regression calculations.

Using the historical information summarized at the beginning of this section, the Zero Inflated Regression Model approach will calculate price independent coefficients (coefficients that do not interact with price) and price dependent coefficients (coefficients that interact with price) for both the Zero Inflated and Non-negative Regression Model components. Using the Zero Inflated regression Model approach there are a number of alternatives for the Non-negative Regression Model. For example, if the quantity whose demand is being modeled takes on integer values, the Non-negative Regression Model could be a Poisson Model (also referred to as a ZIP approach) or a Negative Binomial Model (also referred to as a ZINB approach). If the quantity whose demand is being modeled takes on continuous values, the Non-negative Regression Model could be a Log-Normal Model. In addition, other Non-negative Regression Models could be used. The specific Non-negative Regression Model in any given application is chosen based on the best fit to the customer-specific data defined in Section 4.0. The Zero Inflated Regression Model approach, while never before applied to model demand as described herein, is well known to statisticians and thus not discussed here further.

Note that in performing the statistical inference on how customers react to pricing offers, Customized Pricing does not require an explicit resolution of whether the seller “won” or “lost” the pricing offer. Customized Pricing is concerned strictly with the actual business that the customer does with the seller at the prices offered in the pricing proposal. Again, this is an important difference between the present method and Target Pricing methods.

5.0 Calculate Expected Customer Demand

The expected customer demand for products resulting from a particular pricing proposal or offer is calculated in block 18 as a function of price using the Zero Inflated and Non-negative Regression Model price independent and price dependent coefficients developed in block 16. Note that Customized Pricing does not require a specification of the anticipated or planned demand in order to calculate the expected customer demand. If such anticipated or planned demand is available, it can be used in the calculation, but it is not required.

6.0 Define Customer Segmentation

When customer buying behavior is captured through the statistical inference process defined in block 16, a number of customer characteristics will be statistically significant in determining the Zero Inflated Regression Model. The specific customer characteristics depend on the experience of the seller with each of the customers.

The set of variables that are statistically significant in determining the Zero Inflated Regression Model defines the customer segmentation as determined in block 20. This segmentation is important since Customized Prices are potentially a function of all of the customer segmentation variables.

As an example, characteristics that may prove important are variables such as:
Annual sales of customer (or some measure of customer size);
The customer's annual growth rate;
The industry or industries in which the customer does its business;
The length of time that the seller has had a relationship with the customer;
Past purchasing patterns.

The inventive method for achieving Customized Pricing embodies the segmentation characteristics, where segmentation is based on observable characteristics of the customer or proposal that is statistically significant in predicting customer demand as a function of price.

7.0 Specify the Seller's Performance Metrics

The seller's performance metrics are specified in block 22. These performance metrics are measurable and observable indices that the seller wishes to use in measuring the relative success of selling the product. The seller can use the following performance metrics: Volume, Revenue, Profit, and Return on Capital. These metrics can be used individually or in combination as described in block 24 (section 8.0, below).

8.0 Specify the Seller's Performance Goals

The seller's performance goals, specified in block 24, define what the seller is trying to accomplish in setting Customized Prices. The performance goals or objectives are defined in terms of the seller's performance metrics.

For example, the performance goal of Customized Pricing might be to maximize contribution to profit. This is an example where the single performance metric, contribution to profit, is used. As mentioned in Section 7.0, above, combinations of metrics can also be used in establishing performance goals. For example, the performance goal of Customized Pricing might be to maximize contribution to profit subject to the constraint of achieving a specified minimum level of return on capital.

Performance goals can vary by customer segmentation, other market segmentation such as geography, competitor, and product. For example, a seller might have the performance goals to: (1) maximize contribution to profit for all customers except those in the XYZ industry, and (2) maximize contribution to profit for all customers in the XYZ industry subject to achieving a minimum specified level of expected demand. These goals may or may not be mutually exclusive.

9.0 Calculate the Values of the Seller's Performance Metrics as a Function of Price

For the products in the offer defined in block 14 with the costs defined in block 12, calculate in block 26 the expected demand in block 18 and the values of the performance metrics defined in block 22, all as a function of price.

10.0 Determine the Customized Price that Optimizes the Achievement of the Seller's Performance Goals

Using the values of the seller's performance metrics as a function of price, choose the Customized Price in block 28 that optimizes the achievement of the seller's performance goals as defined in block 26. The optimization may be performed independently over the products in the offer or it may reflect interactions among the products in the offer as appropriate.

11.0 Override the Calculated Customized Price if it Falls Outside the Statistically Valid Range

It is possible that the optimization in block 28 will produce a Customized Price that is outside the statistically valid variation in price as determined in block 16. Query block 30 is operated to determine if the customer price is outside of this range. In this case, the calculated price should be overridden and replaced by the appropriate minimum or maximum of the statistically valid price range in block 32. Otherwise, the calculated customized price from block 28 is maintained in block 34.

12.0 Calculate a Range for the Customized Price

Using the values of the seller's performance metrics as a function of price, choose a Customized Price Lower Limit and Customized Price Upper Limit in block 36 that yield values of the seller's performance goal within a specified tolerance of the value achieved in block 28. The range from Customized Price Lower Limit to Customized Price Upper Limit is the Customized Price range. The objective of a range is to provide sufficient pricing flexibility to support the sales process, without substantially compromising the seller's performance goals.

13.0 Calculate the Benefits of Customized Pricing

The benefit of using Customized Pricing as compared to any alternative pricing approach is determined in block 38 by comparing the value of the seller's performance goal at the Customized Price as determined in block 28 to the value of the seller's performance goal for the alternative pricing approach as determined in block 26. This benefits calculation is based on applying a consistent set of market response and performance measurement assumptions to both Customized Pricing and the alternative pricing approach.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A system for generating Customized Pricing by a seller of products offered to a buyer, comprising:
operative on a computer system, a statistics calibration software module coupled to a computer database and operative to retrieve records of buyer responses to prior pricing proposals stored within the database, said statistics calibration software module generating market response parameters quantifying future buyer behavior from the statistical analysis of the records of buyer responses to prior pricing proposals; and
a pricer software module operative to construct a pricing proposal using the market response parameters generated by the statistics calibration software module.

2. The system of claim 1, further including a strategy tool module coupled to retrieve market response parameters from said statistics calibration software module and strategic goal information from said computer database and generating impacts on price and on said strategic goals cooperative with pricing proposals received from said pricer software module.

3. The system of claim 1, wherein said strategic goals impacts are defined in terms of sales volume, revenue, profit, and return on capital.

4. The system of claim 1, further including a performance monitor software module operative within the system to receive fulfillment history from records of buyer responses to prior pricing proposals, and periodically monitor a variance from a model established from the market response parameters.

5. The system of claim 1, wherein the statistics calibration software module is adapted to model customer behavior using a Zero Inflated Regression Model approach to yield an expected demand for the products as a function of price.

6. The system of claim 5, further including a strategy tool coupled to retrieve market response parameters from said statistics calibration software module and strategic goal information from said computer database and generating impacts on price and on said strategic goals cooperative with pricing proposals received from said pricer software module and being adapted to calculate the seller performance goal as a function of price using the expected customer demand from the price proposal and to select the price proposal to maximize the seller performance goal.

7. The system of claim 5, further including using responses by customers to a seller's past pricing offers in the customer behavior model.

8. The system of claim 5, wherein the behavior model is further enabled by calculating the likelihood that the customer will have a non-zero demand for the offered goods or services as a function of price, and calculating the expected level of non-zero demand for the goods and services as a function of price.

9. The system of claim 5, the system further determining statistically significant characteristics for the customer.

10. The system of claim 6, further including specifying performance metrics of a seller of the goods or services and specifying the seller performance goal using these metrics.

11. The system of claim 10, the system further outputting the price proposal that optimizes the achievement of the seller performance goal.

12. The method of claim 11, the system further selecting a price range characterized by a statistically valid variation in price, including a Customized Price Lower Limit and a Customized Price Upper Limit, and overriding the selected price proposal if it falls outside of this price range.

13. The method of claim 5, wherein the Zero Inflated Regression Model includes both a Zero Inflated and a Non-negative Regression Model component, the Regression Model component being a Poisson Model.

14. The method of claim 5, wherein the Zero Inflated Regression Model includes both a Zero Inflated and a Non-negative Regression Model component, the Regression Model component being a Negative Binomial Model.

15. The method of claim 5, wherein the Zero Inflated Regression Model includes both a Zero Inflated and a Non-negative Regression Model component, the Regression Model component being a Log-Normal Model.

16. A system for generating Customized Pricing by a seller of products offered to a buyer, comprising:
operative on a computer system, a CP statistics calibration software module coupled to a computer database and operative to retrieve database information on records of buyer responses to prior pricing proposals stored within the database, said CP statistics calibration software module generating market response parameters quantifying future buyer behavior from the commercial data;
a CP pricer software module operative to construct a pricing proposal using the market response parameters generated by the CP statistics calibration software module.
a CP strategy tool coupled to retrieve market response parameters from said CP statistics calibration software module and strategic goal information from said computer database and generating impacts on price and on said strategic goals cooperative with pricing proposals received from said CP pricer software module; and
a CP performance monitor operative within the system to receive fulfillment history from the commercial data, and periodically monitor a variance from a model established from the market response parameters.

17. The system of claim 16, wherein the CP statistics calibration software module is adapted to model customer behavior using a Zero Inflated Regression Model to yield an expected demand for the products as a function of price.

18. The method of claim 17, wherein the Zero Inflated Regression Model includes both a Zero Inflated and a Non-negative Regression Model component, the Regression Model component being a Poisson Model.

19. The method of claim 17, wherein the Zero Inflated Regression Model includes both a Zero Inflated and a Non-negative Regression Model component, the Regression Model component being a Negative Binomial Model.

20. The method of claim 17, wherein the Zero Inflated Regression Model includes both a Zero Inflated and a Non-negative Regression Model component, the Regression Model component being a Log-Normal Model.

21. The method of claim 17, wherein the Zero Inflated Regression Model includes both a Zero Inflated and a Non-negative Regression Model component, the Regression Model component being a Count Model.
